(19) United States
(12) Patent Application Publication
(10) Pub. No.: US 2005/0233240 A1
(43) Pub. Date: Oct. 20, 2005

(54) Printed flexible packing material

(75) Inventors: Karolina Rosenberger, Osterfingen (CH); Fabian Bönsch, Balingen (DE)

Correspondence Address: OSTROLENK FABER GERB & SOFFEN, 1180 AVENUE OF THE AMERICAS, NEW YORK, NY, 100368403, US

(73) Assignee: Alcan Technology & Management Ltd.

(21) Appl. No.: 11/159,639

(22) Filed: Jun. 23, 2005

Related U.S. Application Data
(62) Division of application No. 10/363,879, filed on Mar. 7, 2003.

(30) Foreign Application Priority Data
Sep. 7, 2000 (EP) 00810807.8

(51) Int. Cl. G03G 15/20

(52) U.S. Cl. 430/124

(57) ABSTRACT

A flexible packaging material, especially a seal and/or packing material which can be sterilized, having a single film or a film composite with a single or double-print motif. The packing material contains a partially or fully transparent, heat-resistant cover layer applied to at least the print motif by an electro-photographic method. The cover layers are produced from an ultraviolet radiation or electron radiation hardening toner.

### CROSS-REFERENCE TO RELATED APPLICATIONS

This is a divisional of U.S. patent application Ser. No. 10/363,879, filed Mar. 7, 2003 in the names of Karolina Rosenberger and Fabian Bönsch and entitled PRINTED FLEXIBLE PACKING MATERIAL, which is a 35 U.S.C. §371 National Stage of International Application No. PCT/EP2001/10123, filed on Sep. 3, 2001. Priority is claimed on that application and on the following application: Country: Europe, Application No. 00810807.8, filed: Sep. 7, 2000.

### BACKGROUND OF THE INVENTION

The present invention relates to a flexible packaging material, in particular a sealable and/or sterilizable packaging material, made of a single film or a film composite with a print on one or both sides, and also to a method of manufacturing the same and to the use of the packaging material.

Printing on flexible packaging materials, such as paper films, plastic films, metal films or film composites made of two or more of the packaging materials usually takes place by raised printing, for example flexo printing, intaglio printing, flatbed printing, for example offset printing, or through-printing, for example screen printing.

For printing purposes, the printing inks are applied to the packaging material by means of a printing cylinder, printing plate, screen or the like. The expense of printing increases according to the number of colors. The printing pattern has to be transferred to the packaging material by way of one or more printing formes. The printing processes are highly developed and permit economical production of large quantities of packaging materials with uniform printing motifs.

However, printing on small batches of packaging materials is complicated, time-consuming and accordingly expensive because of the manufacture of the printing formes and the changing-over of the printing formes and printing inks in the printing machines. Customers, however, are demanding more and more flexibility. Thus, for example, shorter and shorter delivery times are being set, the layout of the packaging is being changed more frequently according to seasonal activities such as Easter, Christmas, etc., or packaging materials are to be offered in various languages. Furthermore, the incorporation of safety features by means of special printed motifs for protecting against counterfeiting operations is gaining increasing importance. Furthermore, the possibility of printing on packaging materials on both sides is also to be provided.

In the meantime, methods of printing on packaging materials by means of electrophotographic processes have become known, which are equal to the above-mentioned requirements. The printing inks or toners employed in such electrophotographic processes are thermally fixed. Both the fusion and forming of the fusion product and also the fixing onto the packaging material take place in the thermal hardening process.

However, prints manufactured by means of electrophotography and using thermally fixing toner systems are only thermally stable up to around 100° C. When manufacturing packs, however, packaging materials often have to be heated, over part or all of their area, to temperatures of far more than 100° C.

Thus, for example, for sealable packagings, use is made of a heat-sealing lacquer which begins to seal only at around 160° C. Moreover, packaging materials for certain applications have to be sterilizable and must consequently be capable of being heated to temperatures of more than 100° C., and as a rule to around 120° C., without sustaining damage themselves.

So that the print produced by means of electrophotography is not damaged or destroyed by such heat treatments, it is proposed in DE 299 03 364 that the printing ink be embedded between two conventional layers of lacquer, one of which is a low-temperature hot-sealing lacquer.

However, the additional coating of lacquer requires further devices in which the layer of lacquer can be applied to the packaging material by immersion, painting-on, rolling-on, centrifuging, spraying or so called “coil-coating”. Furthermore, the use of lacquers containing solvent is subject to reservations from an ecological point of view.

### SUMMARY OF THE INVENTION

The object of the present invention is to propose a packaging material which is heat-resistant or proof against hot pressing and has a photoelectric print, and also a method of manufacturing the same.

According to the invention, this is achieved through the fact that the packaging material contains a partially or completely transparent, heat-resistant coating layer which is applied at least to the print by means of an electrophotographic process, and the said coating layer is produced from a toner which hardens by ultraviolet or electron radiation.

For the sake of simplicity, toners which harden by means of ultraviolet radiation will be called “UV-hardening toners” below, and toners which harden by means of electron radiation (an electron beam) will be called “EB-hardening toners”.

By definition, an electrophotographic process includes, inter alia, direct and indirect electrophotographic processes such as, for example, xerography, in which use is preferably made of a more indirect electrophotographic process, in particular a xerography process.

The principle of the electrophotographic process is composed of the following partial steps;

The photoconducting surface layer of a photocarrier, for example a copying drum, is uniformly charged in darkness at a corona discharge station. The photoconducting layer is exposed to a light source which reproduces the printing image as an exposure pattern, the exposed part of the photoconducting layer being discharged. A charge image which corresponds to the printing image is produced.

In the developing step, an electrostatically charged toner is transferred onto the charge image, those toner particles which are oppositely charged to the charge of the photoconducting layer being drawn onto the charge image on the photocarrier by the operative electrostatic forces, while reproducing the printing image.

The transfer of the toner onto the charge image preferably takes place by means of a method according to the so-called “EMB technology” (electromagnetic brush technology), such as is employed, in particular, in a two-component developer system. A so-called “carrier” consists in this case of ferromagnetic particles, the toner particles being bonded to the carrier by triboelectric forces. The developer system consisting of the carrier and the toner particles adhering thereto is applied by way of a rotating magnetic roller lying opposite the photocarrier or copying drum. As a result of the magnetic forces operating between the magnetic drum and the carrier, the developer system is drawn against the magnetic drum in the form of a chain and forms a brush-like arrangement, which is also called a “magnetic brush”. The said magnetic brush sweeps over the photocarrier and produces a so-called “brush effect”, as a result of which the toner particles are conveyed onto the charge image of the photocarrier with the aid of electrostatic forces.

In the transfer step, the toner is transferred, for example by means of corona discharges, from the photocarrier onto the substrate which is to be printed on. The toner is then fixed permanently to the substrate, if necessary in the fused condition.

The electrophotographic process is described in detail, for example in “Ullman's Encyclopedia of Industrial Chemistry, Sixth Edition, 1999, Electronic Release: Chapter 2.1.1. Electrophotography”.

The application of a UV-hardening or EB-hardening coating layer by means of electrophotography permits, for example, the use of solvent-free toner systems.

The toner for producing the coating layer is preferably in solid, for example powder, form. The toner may, for example, be a two-component toner or two-component developer, such as dry toner. The said toner may also be a single-component toner. The toner is preferably pigment-free or is pigmented in such a way that the coating layer produced therefrom is at least translucent, and a print lying beneath it remains visible.

A two-component developer, the use of which is preferred, consists of a carrier or developer and the actual UV-hardening or EB-hardening toner. As previously described, the carrier serves for development purposes, that is to say the toner particles are transferred by means of the carrier onto the charge image of the photocarrier.

When use is made, according to the invention, of UV-hardening or EB-hardening toners for manufacturing the coating layer, the fusion and forming of the toner on the substrate which is necessary in certain cases, is disengaged, in contrast to thermally hardening toners, from the actual hardening process.

The UV-hardening or EB-hardening toners contain so-called “initiators”, for example photoinitiators in UV-hardening toners, which burst when suitably power-bombarded with UV or electron radiation, and bring about immediate polymerization of the coat of toner.

In a preferred embodiment of the invention, after being transferred from the photocarrier to the substrate in a so-called “heating station”, for example by means of IR (infrared) radiation or NIR (near infrared) radiation, the toner particles are heated up to, for example, 70-80° C., in particular by means of heated rollers, and optionally fused. A fine, uniform film is formed on the substrate as a result of the fusing operation.

The transfer of the toner and, optionally, the heating-up or fusion of the latter is followed, in a so-called “hardening station”, by the fixing of the toner or fusion product onto the substrate. The concatenating reactions in the toner, which bring about the hardening process, are triggered by means of ultraviolet or electron radiation.

The temperature of the preferably molten toner powder is advantageously increased during hardening, for example to around 70-80° C., in order to guarantee sufficient mobility of the molecules for the hardening operation.

In the case of UV-hardening toners, the hardening process is preferably carried out by means of microwave-generated UV irradiation. As a rule, the hardening process lasts from a fraction of a second to a few seconds.

Suitable UV-hardening or EB-hardening toners, which may be used in the present invention, are described in detail in, for example, WO 97/36049.

The coating layer which is applied on the basis of a UV-hardening or EB-hardening toner exhibits excellent adhesion to the substrate and print. In addition, the coating layer can only be fused again from a temperature of 200° C. or more onwards, and therefore remains stable in the event of the packaging material being heated up as a result of hot-sealing or sterilization. The print, in particular a photoelectric print, which lies underneath it is thereby protected against damage.

The coating layer is preferably a sealing protective layer on the packaging material. The thickness of the said coating layer may be 7-100 μm, and in particular 10-50 μm. The coating layer is preferably a translucent or partially, and in particular completely, transparent layer. The printing image lying beneath it thus remains visible in spite of the coating layer. The said coating layer covers at least that coat of material which produces the printing image. The coating layer preferably masks, all over, at least those sections of the area of the packaging material which are printed on. In a particular embodiment of the invention, the coating layer is applied all over, as a sealing protective layer, to the entire packaging material.

Above the printing image, the coating layer is preferably such that those superficial unevennesses which are produced by sections of the area which are alternately printed on and not printed on, are evened out by the said coating layer, and the packaging film has a flat free surface. The coating layer itself thus has thicknesses which preferably differ across its area. The evening-out of the unevennesses can be achieved, for example, as a result of running of the UV-hardening or EB-hardening toner which has been fused prior to the hardening operation. Furthermore, the application of toner for the purpose of producing the coating layer by the electrophotographic method may be deliberately effected with differing layer thicknesses, for example in the form of a negative image of the printing image, so that a thicker layer of toner is applied at those points on the area which have not been printed on, and a thinner layer of toner at those points which have been printed on.

The print suitably consists of image and/or symbol patterns which contain, for example, symbol sequences, illustrations, patterns, grids, or random patterns. The image and/or symbol pattern may be, for example, in color, black or white or in grey tints.

Printing on the packaging material is preferably likewise effected by means of an aforesaid electrophotographic process in a so-called “printing unit”. For the sake of simplicity, the print manufactured by means of electrophotography is called a “photoelectric print”.

The toner for the photoelectric print may be a conventionally thermally-hardening toner and may be in solid form, for example in powder form or wax-like or resin-like, or in liquid or paste form. The toner may, for example, be a dry toner in powder form or a liquid toner. Use is preferably made of single-component toners made of, for example, resin particles in which, inter alia, pigments are dispersed and, in a particularly preferred manner, of two-component toners with a developer system consisting of a carrier and a pigment toner.

The toner may also be a UV-hardening or EB-hardening toner. Accordingly, a hardening station is disposed after the printing unit and a heating station may optionally be disposed between the said printing unit and the hardening station.

The toner used for the photoelectric print may contain black, white or colored pigments. In the case of a multicolor printing operation, the partial images of the individual colors are preferably applied to the packaging material and fixed one after another.

Parts of the print may also be manufactured by means of raised printing, such as letter-press or flexo printing, intaglio printing, flatbed printing such as heliographic or offset printing, or by means of through-printing such as screen printing. It is conceivably possible, for example, for the packaging material to contain a blank or base print manufactured by means of one of the aforesaid classic printing processes, and for other additional prints to be applied to the packaging material by means of an electrophotographic process of the aforesaid type, and for that side or those sides of the packaging material which has/have the photoelectric print to be provided with a coating layer according to the invention over part or all of its/their area.

On the opposite side from the coating layer, the packaging material may contain a coating of sealing lacquer, in particular a coating of hot-sealing lacquer, over all or part of its area. The said packaging material may also have a coating of sealing lacquer, in particular a coating of hot-sealing lacquer on the free surface of the coating layer, over part or all of the said surface.

The coating layer according to the invention may also be employed, quite generally, as a protective layer for heat-sensitive surfaces of packaging materials.

The packaging material itself may, for example, be a single-layer or multi-layer, film-like material. The exposed sides of the packaging material which is not printed on may be made of plastics, metals or ceramic materials. Multi-layer materials may be film composites consisting of two or more layers or films made of or, for example, containing papers, plastics and/or metal films.

Examples of papers include packing and wrapping papers or label papers. The papers may be glassine, parchment or artificial parchment papers. The surfaces of the papers may be machine-glazed or glazed on one side and may be satined, crêped, colored or non-colored. In certain cases, the papers may contain synthetic fibres. The papers may have, for example, a mass per unit area of 10 to 300 g/m², a mass per unit area of 20 to 180 g/m² being advantageous.

In a possible form of embodiment, the paper has a coating and constitutes a composite material which, on at least one side, is laminated with a plastic film and/or a metal film or carries an extrusion or co-extrusion coating, dispersion coating, paraffin coating, hot-melt coating, wax coating or a layer of lacquer. The extrusion layer may have a mass per unit area of, for example, 1 to 200 g/m², and suitably 1 to 100 g/m². The coating is, in particular, applied right onto the paper in a direct manner. The paraffin, wax or hot-melt coating may, for example, have a mass per unit area of 1 to 20 g/m².

Examples of metal films as the packaging material are films made of iron, steel, copper and preferably aluminum and its alloys. The aluminum films may be made of aluminum having a purity of 98.5, suitably 99.0, and in particular 99.9. Alloys which are highly suitable for films are, for example, made of an aluminum alloy of the series AlMn, AlFeMn, such as AlFe1.5Mn, AlFeSi or AlFeSiMn, for example in a purity of 97.5 or higher, and preferably in a purity of 98.5 or higher. The metal film is preferably an uninterrupted film.

Suitable plastics are polyvinyl chloride (PVC), polyvinylidene chloride (PVDC), polyesters, polycarbonates, polyvinyl acetates, polyolefins and, in particular, polyethylenes (PE), such as high-density polyethylene (HDPE), medium-density polyethylene (MDPE), linear, medium density polyethylene (LMDPE), low-density polyethylene (LDPE)and linear, low-density polyethylene (LLDPE), and then also polypropylenes (PP), such as cast polypropylene (cPP) or biaxially orientated polypropylene (oPP), polyamides (PA) such as polyamide 6, polyamide 11, polyamide 12, polyamide 6.6, polyamide 6.10, polyamide 6.12, or polyamide 6-3-T. The films made of polyamide may be monoaxially or preferably biaxially orientated (oPA). Other suitable plastics are cycloolefin copolymers (COC). These are thermoplastic olefin polymers with an amorphous structure, which in essence constitute copolymers made of ethylene and 2-norbomene or tetracyclododecene. Other preferred plastics are acrylonitrile-butadiene-styrene-copolymers (ABS) or polyblends thereof.

The thickness of the packaging material, may be, for example, from 5 μm to 1000 μm. Thicknesses of 15 to 200 μm are expedient. For papers which are coated, at least on one side, with plastics or with a metal film, the thickness may be from 5 to 500 μm, and preferably 30 to 300 μm. Plastic films are, for example, from 8 to 1000 μm thick. Metal films may have a thickness of 5 to 300 μm, and preferably 10 to 225 μm. If two or more materials form a film composite, the thickness of the latter may be 13 to 500 μm.

Suitable metal/plastic composites may, for example, contain or consist of the layer sequence (Al/plastic), (Al/lacquer), (lacquer/Al/plastic), (plastic/Al/plastic), etc., the specification in brackets describing, in each case, a ply structure which is represented by oblique strokes.

Examples of such composites are: (cPP/oPA/Al/cPP); (oPA/Al/oPA); (oPA/Al/PE); (oPA/Al/PP); (oPA/Al/PVC); (oPA/Al/PE-coated); (oPA/Al/oPA/EAA); (oPA/Al/oPA/HS-lacquer); (PP/oPP/Al/oPP/PP); (PE/oPA/Al/oPA/PE); (PVC/oPA/Al/PVC); (PP/oPA/Al/PP); (Al/PP),where oPA stands for orientated polyamide, oPP for orientated polypropylene, cPP for cast polypropylene, PVC for polyvinyl chloride, PE for polyethylene, PP for polypropylene, EAA for the copolymer of ethylene and acrylic acid, HS-lacquer for hot-sealing lacquer, and Al for aluminum, and the layer thicknesses of the composites preferably lie between 13 and 500 μm. The plastic films or layers and/or the metal films or layers can be printed on.

Pure plastic composites may, for example, contain or consist of the layer sequence (PET/oPA/PE); (PET/oPP/PE) or (PET/LLDPE), etc., where PET stands for polyethylene-terephthalate and LLDPE for linear, low-density polyethylene. Other additional barrier layers may be provided between the individual layers. The layer thicknesses of the composites preferably lie between 13 and 500 μm.

Paper composites may, for example, contain the layer sequence (Al/paper), (plastic/aluminum/paper) or (paper/plastic), etc. The layer thicknesses of the composites preferably lie between 13 and 500 μm.

Carriers for the print may, in particular, be constituted by the surfaces of films or layers made of metals, in particular of aluminum or an aluminum alloy, it being possible to provide the metal surfaces with a primer or basic lacquer. A basic lacquer of this kind contains, for example, up to 20% by weight of fine-grain constituents. The fine-grain constituents are preferably microdispersed silicic acid, talc, silica, natural or surface-pretreated mica and/or organic particles, the latter not being soluble in the basic lacquer or in the solvent of the basic lacquer. Typical primers are, for example, acrylic lacquers or PVC copolymer lacquers and nitrocellulose lacquers.

Other preferred carriers for the print are the surfaces of films or layers made of plastic of the aforesaid type. The plastic films or layers may, for example, be transparent, translucent or opaque and/or superficially coloured or coloured throughout and/or permeated by fillers or reinforcing materials.

In addition, paper layers, for example paper layers of the aforementioned type, may also be carriers for a print.

The packaging material may have a print on one or both sides, and may accordingly contain a coating layer on one or both sides. In addition to the said print on at least one free surface of the packaging material, there may also be a counterprint on the inner side, that is to say the side facing towards the film composite, of an externally and/or internally located film belonging to the film composite. A counterprint is particularly suitable for transparent and translucent films. The counterprint may, for example, be a blank manufactured by means of an aforesaid raised, intaglio, flatbed or through-printing process or by means of an electrophotographic process.

Contaminants on the surface of the packaging materials, such as lubricant residues or decomposition products thereof for example, are removed before the printing-on operation.

The free surfaces of the plastic films may be pretreated by known methods prior to the application of the print. Before being printed on, the said free surfaces may also be covered, wholly or partially, with a ceramic layer which has been applied, for example, in a thin-layer vacuum process.

Ceramic layers made of, for example, SiOₓ, where x may be a number between 1.2 and 2, or made of Al₂O₃, may be produced by sputtering or by chemical or physical vaporisation of target materials, the said ceramic layer being advantageously deposited, in a thickness of 5 to 500 nm (nanometres), on the surface to be acted upon.

The subject of the present invention is also a method of manufacturing a flexible packaging material, in particular a sealable and/or sterilizable packaging material, from a single film or a film composite.

The method is distinguished by the fact that the said packaging material is printed on continuously on one or both sides in a printing unit, and a toner, which hardens by ultraviolet or electron radiation, is applied to the print or prints, over part or all of their area, in a coating unit by means of an electrophotographic process, and the said toner is cured in a hardening station to form a translucent or completely transparent coating layer, using ultraviolet or electron radiation.

The photoelectric printing operation preferably takes place by means of thermally hardening toners. In a preferred embodiment of the invention, a toner which hardens by ultraviolet or electron radiation is applied to the print or prints, over part or all of their area, in a coating unit by means of an electrophotographic process, the said toner being heated up, and preferably heated up and fused, in a heating station disposed after the coating unit, and being cured immediately afterwards, under the influence of ultraviolet or electron radiation, in a hardening station following the said heating station to form a translucent or completely transparent coating layer.

The printing unit is preferably a continuous installation for printing on film and the packaging material, which is preferably in roll form, is preferably printed on in a continuous manner once or a number of times with one or more printing inks by means of a said electro-photographic process.

The printing unit, the coating unit, optionally the heating station, and the hardening station are preferably disposed in series and are part of a production installation.

When embodying the invention, it is also possible to integrate into the said production installation additional device modules disposed after the aforesaid device modules, for the purpose of continuously manufacturing packagings or packs.

The photoelectric print is preferably multicolored. In a multicolor print, the partial images of the individual colors are preferably applied to the packaging material and fixed one after another. To that end it is possible, for example, to provide in the printing unit a number of printing stations, in each of which the partial image of a corresponding color is printed. Here, the packaging material runs through the various printing stations one after another. The partial images may also be transferred one after another, by various photocarriers, in particular copying rollers, onto a rotating transfer band, and be transferred from the said transfer band onto the packaging material and fixed one after another.

In a further embodiment according to the invention, the packaging material contains a blank or base print which has been manufactured by means of raised printing, in particular letter-press or flexo printing, intaglio printing, flatbed printing, in particular offset or heliographic printing, through-printing, in particular screen printing, or by means of electrophotography, one or more further photoelectric prints being applied to the surface containing the blank, or to a translucent or transparent film or layer disposed above the said surface, by means of an electrophotographic process in a continuous installation for printing on film.

Digital methods of electrophotography are particularly preferred. In these methods, an image pattern and/or symbol pattern in the form of a digital printing original is prepared, employing means for electronic data processing (EDP) and using image-processing and/or word-processing programs, or is read in by means of scanners from a printing original, for example a printout, available in analogue form, and is converted into a digital printing original by way of an analogue-to-digital converter. The printing original made available in digital form is reproduced into a latent image, for example by means of a laser beam in an electrophotographic process, and is transferred, as a printing image, onto the packaging material electrophotographically in the manner described above. The data of the printing original may, for example, be stored on a magnetic, magneto-optical or optical storage medium.

When digital electrophotography is used, it is possible to process two or more printing originals by means of EDP, for example by way of word-processing and/or image-processing programs, to form a complete image pattern and/or symbol pattern, that is to say a printing image. In addition to a printing original, it is possible to copy in, for example, a further printing original which changes continuously for each area which is to be printed on, or changes in a different sequence, in which connection “copying-in” or “copying” is to be understood to mean the reproduction of a printing original which is suitably available in the form of electronic data. This makes it possible to produce, for example, serial numbers, safety notices, printed pattern packaging materials or packaging materials of different colors for individual packagings and the like, in one working operation. A printing original may be reproduced once and/or a number of times.

The coating unit is preferably a continuous film-coating installation. The so-called “hardening station” is incorporated downstream of the said continuous film-coating installation. The packaging material which has been printed on and which is preferably fed in directly from a continuous installation for printing on film or from a roll, is preferably guided continuously through the continuous film-coating installation, coated with the said UV-hardening or EB-hardening toner, and guided through the hardening station in which the toner is cured by means of UV or electron radiation to form a coating layer.

In a preferred embodiment of the invention, a heating station is provided after the continuous film-coating installation and before the hardening station. Here, the packaging material which has been printed on and coated with the UV-hardening or EB-hardening toner is guided, before the actual hardening process, through the heating station in which the toner is fused, and the said packaging material is then transported through the hardening station in which the fused toner is cured by means of UV or electron radiation to form the coating layer.

A packaging material having a coating layer according to the invention is particularly suitable for manufacturing sterilizable packagings for food or animal feed. The packaging material is also suitable for manufacturing sealable packagings such as, for example, press-through packs. The packaging material is particularly suitable for sealable lid materials for containers or carrier bags, sealable bags, flat bags, bottom bags, standing bags, paper bags, wrap-round packagings or cushion packagings, and also carrier bags or bottom parts of press-through packs and blister packs.

Examples of packaging materials according to the invention which have been printed on are packaging films or lid films as packaging means for, for example, cheese such as soft cheese, cheese spread or cream cheese, or for dairy products, in particular for yogurt, such as natural or flavored yogurt, creamy dessert dishes and cream, and also for dehydrated food preparations or instant products such as soups and the like. Examples of such packaging materials have the following film structure, which is described from the outside inwards:

a) coating layer with a thickness of 7 to 80 μm,

b) print;

c) paper with a weight per unit area of 20 to 100 g/m², in particular from 35 to 50 g/m²;

d) all-over adhesive layer with a weight per unit area of 2 to 6 g/m², and in particular 3 to 5 g/m²;

e₁) plastic film made of polyethyleneterephthalate (PET) having a thickness of 8 to 16 μm, and in particular 12 μm, which film is metallised, on the side pointing towards the layer of adhesive d), in a thickness of 10 to 60 nm, and preferably 10 to 30 nm;

e₂) plastic film made of polyethyleneterephthalate (PET) having a thickness of 8 to 16 μm, and in particular 12 μm;

f) primer or lacquer with a weight per unit area of 0.3 to 3.0 g/m², and in particular 0.5 to 1.0 g/m²;

g) Sealing lacquer, in particular a hot-sealing lacquer, preferably based on vinyl/acrylic, or PVC/acrylic, with a weight per unit area of 1 to 4 g/m², and in particular 1.9 to 2.5 g/m².

The packaging film or lid film contains a layer made of PET, either with metallising e₁) or without metallising e₂). Instead of the layer of primer or lacquer f) and the layer of sealing lacquer g), it is also possible to provide a plastic film of polyethylene (PE) having a thickness of 40 to 60 μm, and in particular 50 μm, which film is laminated onto the PET film over an adhesive layer having a weight per unit area of 1.0 to 1.8 g/m², and in particular 1.4 g/m².

The packaging film or lid film according to the invention which has been printed on may also contain a metal film made of aluminum, and may have the following structure:

a) coating layer having a thickness of 7 to 80 μm;

b) print;

c) paper with a weight per unit area of 20 to 100 g/m², and in particular 50 g/m²;

d) all-over layer of adhesive with a weight per unit area of 2 to 6 g/m², and in particular 4 g/m²;

e) aluminum film having a thickness of 6 to 12 μm, and in particular 7 μm;

f) all-over layer of adhesive with a weight per unit area of 1 to 3 g/m², and in particular 1.4 g/m²;

g) plastic film made of polyethylene (PE) having a thickness of 15 to 80 μm, and in particular 45 to 55 μm.

Another packaging material according to the invention, which has been printed on and has an aluminum film, contains the following film structure, from the outside inwards:

a) coating layer with a thickness of 7 to 80 μm;

b) print;

c) primer or lacquer with a weight per unit area of 0.8 to 3.0 g/m², and in particular 1.1 g/m²;

d) aluminum film having a thickness of 15 to 25 μm, and in particular 20 μm;

e) all-over layer of adhesive with a weight per unit area of 2 to 5 g/m², and in particular 3.5 g/m²;

f) plastic film made of polyethyleneterephthalate (PET) having a thickness of 8 to 16 μm, and in particular 12 μm;

g) primer or lacquer with a weight per unit area of 0.3 to 3.0 g/m², and in particular 0.6 g/m²;

h) sealing lacquer, in particular a hot-sealing lacquer, preferably based on PVC/acrylic with a weight per unit area of 1 to 4 g/m², and in particular 2.5 g/m².

Other packaging materials according to the invention which can be printed on are food containers, such as tubs, trays, in particular ready-meal trays made of a film of an AlMn1Mg0.5 alloy (AA 3005) having a thickness of 70 to 110 μm, and in particular 90 μm, with an externally located bare side and an inner film made of polypropylene (PP) with a thickness of 20 to 40 μm, and in particular 30 μm, which film has been applied over a lamination of lacquer having a weight per unit area of 4.0 to 6.0 g/m², and in particular 5.0 g/m². Instead of a bare outer side, it is also possible to provide stove-enamelling in gold or the like having a weight per unit area of 2 to 5 g/m², and in particular 3.5 g/m², on the aluminum film.

Apart from the above mentioned Al alloy, the said tubs and trays may also be made of a film of an Al98.6 alloy having a thickness of 50 to 70 μm, and in particular 60 μm, the said aluminum film having an outer glossy side which is bare or has a printing undercoat having a mass per unit area of 1.3 to 1.7 g/m², and in particular 1.5 g/m², and an inner matt side with a bonding agent having a weight per unit area of 1.2 to 1.6 g/m², and in particular 1.4 g/m², and with a peelable coating made of polypropylene (PP) having a weight per unit area of 20 to 30 g/m², and in particular 25 g/m², which coating is applied onto the matt side or onto the bonding agent. Instead of a printing undercoat, stove-enamelling in gold or the like having a weight per unit area of 2 to 5 g/m², and in particular 3 g/m², may also be provided on the glossy side. The print and the coating layer may be applied to the outer and/or inner side of the aluminum film or to a primer or layer of lacquer or plastic film lying above the said aluminum film. Other types of alloy which may be used instead of the aforementioned ones are, for example, Al99 or AlFe1.5 Mn (AA 8006, AA 8014).

Examples of pharmaceutical packagings, in particular blister packagings, according to the invention which can be printed on have the following layer structure, which is indicated from the outside inwards:

a) layer of lacquer with a weight per unit area of 0.8 to 1.5 g/m², based on cellulose nitrate, cellulose nitrate charged with Syloid, polyester, or on polyester melamine resin;

b) aluminum film having a thickness of 10 to 30 μm, and in particular 20 μm;

c) layer of lacquer with a weight per unit area of 5 to 9 g/m², and in particular 7 g/m², based on vinyl/acrylic, vinyl chloride-vinylidene chloride copolymer/vinyl chloride-vinyl acetate copolymer/acrylate, or on modified polypropylene.

The photoelectric print and the coating layer may be applied to the outer and/or inner side of the aluminum film or on one of the adjoining layers of plastic.

Other examples have the following layer structure, from the outside inwards:

a) glassine paper with a weight per unit area of 30 to 40 g/m², and in particular 35 g/m²;

b) laminating adhesive with a weight per unit area of 1 to 4 g/m², and in particular 3 g/m², based on polyurethane;

c) aluminum film having a thickness of 6 to 12 μm, and in particular 9 μm;

d) primer or lacquer with a weight per unit area of 1.0 to 1.4 g/m², and in particular 1.2 g/m²;

e) lacquer with a weight per unit area of 4 to 8 g/m², and in particular 6 g/m², based on polyester,

or

a) paper with a weight per unit area of 30 to 60 g/m², and in particular 50 g/m²;

b) laminating adhesive with a weight per unit area of 1 to 3 g/m², and in particular 2 g/m², on a water-soluble base;

c) aluminum film having a thickness of 6 to 12 μm, and in particular 9 μm;

d) bonding agent with a weight per unit area of 0.8 to 1.2 g/m², and in particular 1.0 g/m², based on polyurethane;

e) plastic film made of low density polyethylene (LDPE) having a thickness of 30 to 50 μm, and in particular 40 μm.

The print and the coating layer may be applied to the outer side of the glassine paper and/or to the inner side of the aluminum film or plastic layer or plastic film.

What is meant by “outer side” or “outside” is that side or position which faces away from the contents of the packaging, and what is meant by “inner side” or “inside” is that side or position which faces towards the contents of the packaging.

### BRIEF DESCRIPTION OF THE DRAWINGS

The invention will be explained in greater detail below on an exemplary basis and with reference to the accompanying drawings, in which:

FIG. 1 shows a diagrammatic representation, in cross-section, of a device for printing on a packaging material and for applying a coating layer according to the invention to the packaging material which has been printed on; and

FIG. 2 shows a cross-section through a packaging material according to the invention.

### DETAILED DESCRIPTION OF THE PREFERRED EMBODIMENTS

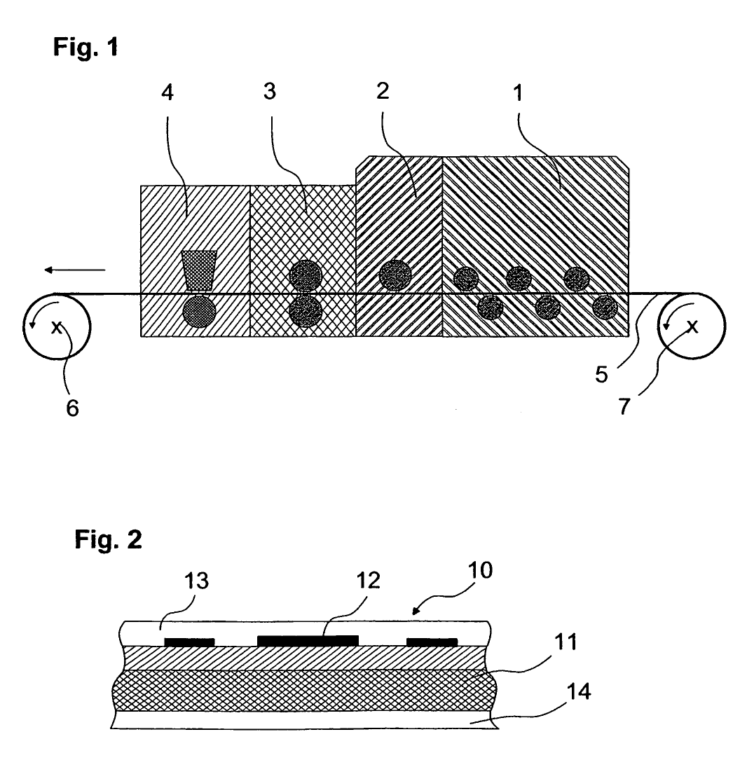

A packaging material 5 in web form which has been previously printed on or has not been printed on is reeled off from a roll 7 and guided through a continuous installation for printing on film 1 (see FIG. 1), in which a single-colored or multicolored print is applied to the packaging material 5 by means of an electrophotographic process once or a number of times with one or more toners having different pigmentation. Thermally hardening dry toners belonging to a two-component developer system are employed as the toners. After being printed on photoelectrically, the packaging material 5 is guided through a continuous film-coating installation 2 incorporated downstream of the continuous installation for printing on film 1. In this installation 2, a UV-hardening or EB-hardening, pigment-free toner which covers the whole area is applied to the print by means of a further electrophotographic process. The UV-hardening or EB-hardening toner is fused in a subsequent heating station 3 and, immediately afterwards, is hardened in a hardening station 4 by means of UV or electron radiation. The packaging material which has been printed on and provided with the coating layer is then wound onto a roll 6 again, or further processed in a continuous manner in a subsequent packaging device to form packaging containers or packaging lids.

In a modified embodiment of the invention, the heating station 3 may even be omitted, so that the packaging material 5 which has been printed on and coated with the UV-hardening or EB-hardening toner is guided directly through the hardening station 4.

As illustrated in FIG. 2, a packaging material 10 according to the invention contains a single film or film composite 11 provided with a photoelectric print 12. The photoelectric print 12 is the fusion product of a thermally fixed dry toner. According to the invention, a coating layer 13 which is applied by means of an electrophotographic process and is based on a UV-hardening or EB-hardening toner, is applied to the surface containing the photoelectric print.

The coating layer 13 evens out the unevennesses brought about by the photoelectric print 12, so that the surface of the coating layer 13 is comparatively flat.

A layer of hot-sealing lacquer 14 is applied to that free surface of the film composite 11 which is the opposite surface from the photoelectric print 12. The layer of hot-sealing lacquer 14 may be applied partially to actual sealing faces or all over the entire foil composite 11. The layer of hot sealing lacquer 14 may also be applied to the coating layer 13.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A method for continuously manufacturing a flexible packaging material made of one of a single film and a film composite, the method comprising the steps of:
continuously printing on at least one side of the film with an electrophotographic process using a toner; applying a coating layer at least over the print by means of an electrophotographic process using one of a UV and EP hardening toner; and curing the coating layer in a hardening station to form a translucent or completely transparent coating layer, using one of ultraviolet or electron radiation.

2. A method according to claim 1, wherein the printing step includes printing on at least one side of the film by an electrophotographic process, using one of a UV and EP hardening toner.

3. A method according to claim 2, including applying step includes applying a toner which hardens by ultraviolet or electron radiation to the photoelectric print or printing prints over at least part of an area of the print by means of an electrophotographic process, the applying step further including heating the toner in a heating station, and afterwards immediately curing the toner in the hardening station under influence of ultraviolet or electron radiation to form a translucent or completely transparent coating layer.

4. A method according to claim 3, wherein the toner applying step includes heating and fusing the toner.

5. A method according to claim 1, wherein the printing step includes printing on the film at least once in a continuous manner with at least one printing ink, the coating being carried out in a continuous manner.

6. A method according to claim 1, including providing the packaging material with a blank or base print by one of raised printing, intaglio printing, flatbed printing, through-printing and by electrophotography, and applying at least one further photoelectric print one of to the surface containing the blank or base print and to a translucent or transparent film disposed above the surface, by means of an electrophotographic process in a continuous installation for printing on film.

7. A method according to claim 6, including providing the packaging material with a blank or base print by one of letter press and flexo printing.

8. A method according to claim 6, including providing the packaging material with a blank or base print by one of offset and heliographic printing.

9. A method according to claim 1, including providing the packaging material with a blank or base print by screen printing.

10. A method according to claim 1, including applying a multicolored print to the packaging material.

11. A method according to claim 10, including transferring variously colored toners formed as partial images, from a photocarrier to the packaging material by means of a transfer band.

12. A method according to claim 1, including preparing at least one of an image pattern and a symbol pattern as a printing original by electronic data processing (EDP) and using at least one of image-processing and word-processing programs, and making data of the printing original available in digital form, and reproducing the printing material original onto the packaging material as a print by an electrophotographic process.

13. A method according to claim 1, wherein the steps of printing and applying a coating layer are process steps which are integrated into a continuous method of manufacturing packagings or packs.

14. A flexible packaging material produced by the method of claim 1, comprising: a film having a print on at least one side; and an at least partially transparent, heat-resistant coating layer applied at least over the print, said coating layer being a concatenated polymer structure cured by one of untraviolet and electron radiation.

15. A flexible packaging material according to claim 14, wherein the coating layer covers at least those sections of an area of the packaging material which have been printed on.

16. A flexible packaging material according to claim 15, wherein the coating layer covers all of the packaging material.

17. A flexible packaging material according to claim 16, wherein the coating layer is applied so as to even out unevennessses on the packaging material which are caused by sections of the area which have been alternately printed on and not printed on so that the packaging material forms a flat, free surface.

18. A flexible packaging material according to claim 14, and further comprising a coating of sealing lacquer over at least part of an area of the film on a side opposite from the coating layer.

19. A flexible packaging material according to claim 18, wherein the coating of sealing lacquer is a coating of hot-sealing lacquer.

20. A flexible packaging material according to claim 14, and further comprising a coating of sealing lacquer applied to a free surface of the coating layer over at least part of its area.

21. A flexible packaging material according to claim 20, wherein the sealing lacquer is a hot-sealing lacquer.

22. A flexible packaging material according to claim 20, wherein the sealing lacquer is applied over all the area of the free surface of the coating layer.

23. A flexible packaging material according to claim 14, and further comprising a translucent or transparent layer of plastic applied to at least a portion of an area of a free surface of the coating layer.

24. A flexible packaging material according to claim 14, wherein the coating layer is completely transparent.

25. A flexible packaging material according to claim 14, wherein the material is at least one of sealable and sterilizable.

26. A flexible packaging material according to claim 14, wherein the film is a film composite.
